(19) United States
(12) Patent Application Publication
(10) Pub. No.: US 2013/0226319 A1
(43) Pub. Date: Aug. 29, 2013

(54) ORIGIN SETTING METHOD AND APPARATUS USING THE SAME

(71) Applicant: Ryota Itani, Chiyoda-ku (JP)

(72) Inventor: Ryota Itani, Chiyoda-ku (JP)

(73) Assignee: MITSUBISHI ELECTRIC CORPORATION, Chiyoda-ku, Tokyo (JP)

(21) Appl. No.: 13/816,901

(22) PCT Filed: Sep. 22, 2010
(86) PCT No.: PCT/JP2010/005730

§ 371 Date: Apr. 11, 2013

(51) Int. Cl. G05B 19/19

(52) U.S. Cl. CPC G05B 19/19
USPC 700/60

(57) ABSTRACT

In an origin setting method for a machine in which a single mechanical movement axis is servo-controlled and driven cooperatively by two control shafts, structural shaft parts of the control shafts, which are moved by driving the control shafts, are moved until the structural shaft parts are brought into contact with mechanical end stoppers, a contact detection position of each control shaft is read and memorized and a droop amount of each control shaft is cleared under a condition that each structural shaft part is in contact with the mechanical end stopper, and then, the structural shaft parts are moved apart from the mechanical end stoppers by a predetermined amount, and positions moved by the predetermined amount are set as origins on a basis of the memorized contact detection positions; whereby, even if a mechanical part bridging the two shafts and movably placed thereon has a deviation in perpendicularity, the origins are precisely set with references to the mechanical end stopper positions for the two shafts, with a simple configuration.

### TECHNICAL FIELD

The present invention relates to an origin setting method for setting the origin of a numerical control (hereinafter, abbreviated as NC) machine tool or the like and an apparatus using the same, especially to those in which an origin is set by servo-controlling two parallel control shafts constituting a single mechanical movement axis and synchronously controlling both shafts.

### BACKGROUND ART

When using a machine tool, there is a case in which a workpiece is heavy or the tool is a large machine. In this case, in order to resolve a shortage in motor torque and improve machining accuracy, a servo control and a synchronous control are sometimes employed for two parallel control shafts (a primary shaft and a secondary shaft) constituting a single mechanical movement axis by two servomotors (sometimes referred to as “two-shaft drive”, “two-wheel drive”, “dual drive”, “master/slave control”, or the like). An example configuration is shown in FIG. 1 in which an NC apparatus servo-controls and synchronously controls the servomotors for the two shafts. Basically, synchronization control can be realized by outputting identical movement instruction data from a shaft instruction generation unit of the NC apparatus to servo-control units that synchronously control the primary shaft and the secondary shaft.

To operate the machine tool according to a machining program in the NC apparatus, it is necessary to set in advance a coordinate system origin on the machine for giving a meaning to an instruction value. Here, if a machine origin (a reference point of the machine coordinate system) is defined in advance and is stored in a nonvolatile memory, operation can be started at a next power-on without origin setting, as long as a mechanically movable part is not moved when applying external force after power off.

Origin setting methods are generally classified into two types: a dog type and a dogless type; and the subject of the present invention relates to a kind of dogless type, i.e. a push-contact type (or bump-contact type) origin setting method. The essence of the push-contact type origin setting method is that a motor for a shaft of a machine tool is driven by a limited current generating only such torque for the shaft not to damage the machine and the like, and a structural shaft part moved by the control shaft that the motor drives is pushed against a mechanical end stopper or the like to define its position as its reference point.

Patent Document 1 discloses an origin setting technique that uses a grid method, in which the master shaft (primary shaft) and the slave shaft (secondary shaft) are once returned to origins at a machine setup, so that the grid position difference (deviation amount) between the two shafts is automatically calculated and stored as a parameter, and when completing the second and subsequent origin return operations, the origin position of the slave shaft is defined as [origin position of the master shaft+deviation amount].

Furthermore, Patent Document 2 discloses an origin setting technique for a control unit that detects the position of a single shaft of a machine tool by pushing the shaft into contact with an end stopper of the machine, in which the mechanical contact is detected by extracting a torque signal from a motor drive signal and comparing the torque with a reference value, and then accumulated pulses are cleared and the detected position is set as a reference position; or after clearing the accumulated pulses, set as the reference position is a position reversely moved by a predetermined amount or a position at which a Z-phase signal is detected for the first time.

### PRIOR ART DOCUMENT

### Patent Document

[Patent Document 1]
Japanese Patent Laid-Open No. H08-22313
[Patent Document 2]
Japanese Patent Laid-Open No. H09-44252

### DISCLOSURE OF INVENTION

### Problem to be Solved by the Invention

However, for example, in a case where it is difficult to measure a grid shift amount for defining the origin positions of two parallel shafts in a large machine performing so-called two wheel drive, an origin position error between the two shafts is eliminated according to the first conventional technique (Patent Document 1) in which the difference between values of reference counters counting position feedback pulses from pulse coders installed on the two shafts is stored in advance as a position deviation amount as a parameter, and then in an origin return operation, the position deviation amount is read out from the parameters in a shifting operation to return the master shaft to origin, so that the position deviation amount is added to the grid shift amount for the slave shaft. In this way, position errors of both shafts are eliminated. This eliminates a manual measurement of the grid shift amount, but requires a precondition that a mechanical part bridging the two parallel shafts is perpendicular to the shafts. If external force produces a deviation in perpendicularity, the origin return operation does not eliminate the deviation.

Furthermore, in the second technique (Patent Document 2), a push-contact stopper position is used as a reference for the origin setting in which when the mechanical slider hits the end of the carriage shaft to cause a torque signal of the servomotor to exceed a predetermined reference value, the movement instruction is stopped to set the origin and clear the accumulated pulses, and then the motor is reversed by a predetermined value or until a Z-phase signal is detected.

However, because the second technique is for setting an origin for a single shaft only, a simple application of the origin setting technique to the apparatus having two shafts (a master shaft and a slave shaft) and using an existing method of controlling the master shaft and the slave shaft with the same instruction (a method basically unable to independently control each of the master shaft and the slave shaft) causes, with a large possibility, a backward movement of one of the shafts before hitting the stopper, even though the origin setting is performed as shown in FIG. 8, in a case where the mechanical part has a deviation in perpendicularity, or in a case where some kind of external force produces a perpendicular deviation in the mechanical part. In such cases, the deviation is not eliminated similarly to the first technique, and the origins are not set correctly.

The present invention is made to solve the problems and aims to obtain an origin setting method and an apparatus using the same in which even if the mechanical part has a deviation in perpendicularity, the origins of the primary shaft and the secondary shaft can be precisely set using a push-contact method.

### Means for Solving Problem

An origin setting method for a machine in which two control shafts constituting a single mechanical movement axis are cooperatively servo-controlled and driven, includes: a step of moving structural shaft parts of the respective control shafts, which are moved by driving the control shafts, until the structural shaft parts are brought into contact with respective mechanical end stoppers; a step of detecting contact between each structural shaft part and the mechanical end stopper; a step of reading and memorizing a contact detection position of each control shaft under a condition that each structural shaft part is in contact with the mechanical end stopper; a step of clearing a droop amount of each control shaft under the condition that each structural shaft part is in contact with the mechanical end stopper; and a step of setting origins to positions obtained by moving the structural shaft parts from the memorized contact detection positions by a predetermined amount apart from the mechanical end stoppers.

Another origin setting method for a machine in which two control shafts constituting a single mechanical movement axis are cooperatively servo-controlled and driven, includes: a step of measuring an installation position error between positions at which structural shaft parts of the control shafts, which are moved by driving the control shafts, are in contact with respective mechanical end stoppers; a step of memorizing a value of the installation position error; a step of moving the structural shaft parts, until the structural shaft parts are brought into contact with the respective mechanical end stoppers; a step of detecting contact between each structural shaft part and the mechanical end stopper; a step of reading and memorizing a contact detection position of each control shaft under a condition that each structural shaft part is in contact with the mechanical end stopper; a step of clearing a droop amount of each control shaft under the condition that each structural shaft part is in contact with the mechanical end stopper; a step of eliminating the installation position error between the mechanical end stoppers, on a basis of the memorized value of the installation position error; and a step of setting origins to positions obtained by moving the structural shaft parts from the memorized contact detection positions by a predetermined amount apart from the mechanical end stoppers.

An origin setting apparatus in a machine in which two control shafts constituting a single mechanical movement axis are cooperatively servo-controlled and driven, includes: a movement means that moves structural shaft parts of the respective control shafts, which are moved by driving the control shafts, until the structural shaft parts are brought into contact with respective mechanical end stoppers; a contact detection means that detects contact between each structural shaft part and the mechanical end stopper; a detected-contact-position memorization means that reads and memorizes a contact detection position of each control shaft under a condition that each structural shaft part is in contact with the mechanical end stopper; a droop amount clearing means that clears a droop amount of each control shaft under the condition that each structural shaft part is in contact with the mechanical end stopper; and an origin setting means that sets origins to positions obtained by moving the structural shaft parts from the contact detection positions, memorized in the detected-contact-position memorization means, by a predetermined amount apart from the mechanical end stoppers.

Another origin setting apparatus in a machine in which two control shafts constituting a single mechanical movement axis are cooperatively servo-controlled and driven, includes: an error memorization means that memorizes an installation position error between mechanical end stoppers with which respective structural shaft parts of the control shafts, which are moved by driving the control shafts, are brought into contact; a movement means that moves structural shaft parts until the structural shaft parts are brought into contact with the respective mechanical end stoppers; a contact detection means that detects contact between each structural shaft part and the mechanical end stopper; a detected-contact-position memorization means that reads and memorizes a contact detection position of each control shaft under a condition that each structural shaft part is in contact with the mechanical end stopper; a droop amount clearing means that clears a droop amount of each control shaft under the condition that each structural shaft part is in contact with the mechanical end stopper; a position error elimination means that eliminates the installation position error between the mechanical end stoppers, on a basis of an error value memorized in the error memorization means; and an origin setting means that sets origins to positions obtained by moving the structural shaft parts from the contact detection positions, memorized in the detected-contact-position memorization means, by a predetermined amount apart from the mechanical end stoppers.

### Effect of the Invention

According to the present invention, the origins of two shafts can be precisely set with reference to mechanical end stopper positions with a simple configuration, even if a mechanical part bridging the two shafts and movably placed thereon has a deviation in perpendicularity.

Furthermore, according to the present invention, the origins of two shafts can be precisely set with a simple configuration, even if a mechanical part bridging the two shafts and movably placed thereon has a deviation in perpendicularity and the mechanical end stopper positions of the two shafts are misaligned.

### BRIEF DESCRIPTION OF DRAWINGS

FIG. 1 is a block diagram illustrating a configuration example of an NC system according to Embodiment 1 of the present invention;

FIG. 2 is a view of a situation for explaining Embodiment 1 of the present invention, in which there exists an installation error between mechanical end stopper positions for a primary shaft and a secondary shaft;

FIG. 3 is a flow chart showing an operation according to Embodiment 1 of the present invention, by which a stopper installation error between the primary shaft and secondary shaft is set;

FIG. 4 is a table listing parameters used in the NC system according to Embodiment 1 of the present invention;

FIG. 5 is a flow chart showing an origin setting operation according to Embodiment 1 of the present invention;

FIG. 6 is a flow chart showing details of a reference point recognition process in FIG. 5;

FIG. 7 is a view illustrating the origin setting operation according to Embodiment 1 of the present invention; and

FIG. 8 is a view illustrating an example of an origin setting operation according to a conventional technique.

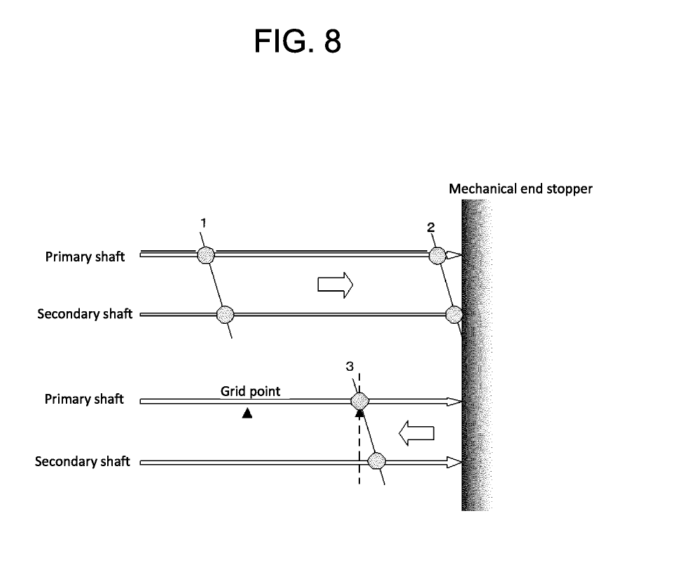

### BEST MODE FOR CARRYING OUT THE INVENTION

### Embodiment 1

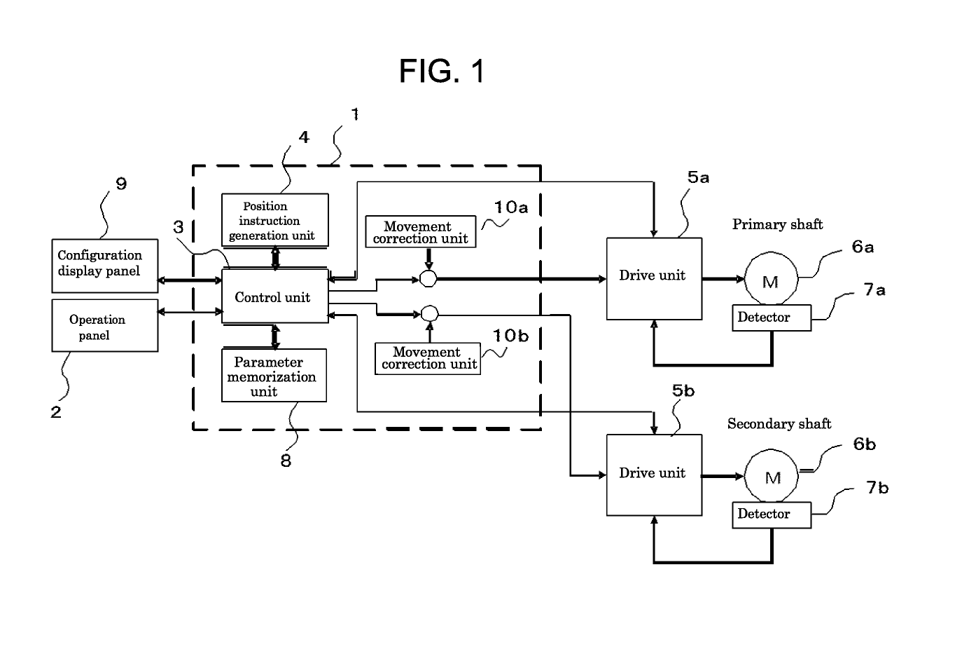

An explanation for Embodiment 1 of the present invention (an origin setting method and a machine tool NC system including an apparatus using the same) will be made below in detail, using FIG. 1 to FIG. 7.

FIG. 1 is a block diagram illustrating a configuration example of the NC system according to Embodiment 1 of the present invention. In the figure, “1” denotes an NC apparatus; “2”, an operation panel for operating machines through the NC apparatus 1; “3”, a control unit for realizing various functions of the NC apparatus 1; “4”, a position instruction generation unit that automatically or manually generates movement instructions for motors; “5a”, a drive unit that drives and controls a servomotor 6a for a primary shaft; “5b”, a drive unit that drives and controls a servomotor 6b for a secondary shaft; “6a”, the servomotor that drives the primary shaft; “6b”, the servomotor that drives the secondary shaft; “7a”, a detector that detects rotation of the servomotor 6a; “7b”, a detector that detects rotation of the servomotor 6b; “8”, a parameter memorization unit that memorizes parameters necessary for controlling the NC apparatus 1; “9”, a configuration display panel; “10a”, a movement correction unit that corrects mechanical errors or the like with respect to the primary shaft; and “10b”, a movement correction unit that corrects mechanical errors or the like with respect to the secondary shaft.

In addition, in typical machining (automatic operation), the secondary shaft is controlled using the same movement data as that calculated for the primary shaft; however, a lost motion correction and a pitch error correction or the like for mechanical error is inputted from, for example, the movement correction units 10a and 10b to correct such an error individually for the primary shaft and the secondary shaft.

In this embodiment, the NC apparatus 1 is composed of the control unit 3, the position instruction generation unit 4, the parameter memorization unit 8, and the movement correction units 10a and 10b.

Moreover, in this embodiment, a movement means is mainly composed of the servomotors 6a and 6b; a contact detection means is mainly composed of the control unit 3 and the drive units 5a and 5b; a detected-contact-position memorization means is mainly composed of the parameter memorization unit 8; a droop amount clearing means is mainly composed of the control unit 3 and the drive units 5a and 5b; an origin setting means is mainly composed of the servomotors 6a and 6b, the drive units 5a and 5b, and the control unit 3; and a position error elimination means is mainly composed of the servomotors 6a and 6b, the drive units 5a and 5b, and the control unit 3.

It is common knowledge that the objects to be actually put into contact with mechanical end stoppers for origin setting are neither the primary shaft nor the secondary shaft themselves, but are structural shaft parts moved by the primary shaft and the secondary shaft.

Next, an explanation will be made for operations of the NC system configured as described above.

A worker (operator) selects an operation mode such as a manual mode and an automatic mode, using the operation panel 2 of NC apparatus 1. In the manual mode, after selection of a shaft, for example the primary shaft, intended to move and of its speed, the selected shaft is moved at the specified speed by pushing a “+” or “−” JOG button. In addition, these movement instructions are generated in the position instruction generation unit 4 through the control unit 3 during the period of pushing the JOG button.

On the other hand, in a handle mode, a movement direction and a movement speed are determined according to the rotation direction and the rotation speed of the handle.

If a movement instruction is for the primary shaft, it is outputted from the control unit 3 to the drive unit 5a, as data for movement per unit time. Here, the primary shaft and the secondary shaft are synchronously controlled as parallel shafts; therefore, the same data for movement per unit time as that the control unit 3 outputs for the primary shaft is outputted for the secondary shaft to the drive unit 5b. The drive units 5a and 5b accumulate the movement data in the drive units 5a and 5b to generate instruction positions. On the other hand, the detectors 7a and 7b joined to the servomotors 6a and 6b output feedback pulses corresponding to their motor rotation amounts to the drive units 5a and 5b. In the drive units 5a and 5b, the feedback pulses are accumulated as feedback positions, and the differences (droops) between the instruction positions and the feedback positions are converted into electric power to be supplied to the servomotors 6a and 6b for them to rotate, respectively. At a time point when the droops become zero, the drive units 5a and 5b determine that the respective shafts reach target positions, to stop the motors.

Although the primary shaft and the secondary shaft are thus controlled using the identical movement data, an instruction value except that commonly used, i.e. a correction amount such as a lost motion correction and a pitch error correction that depend on the individual shafts, is added by the movement correction units 10a and 10b to respective outputs of the control unit 3 for the primary shaft and the secondary shaft.

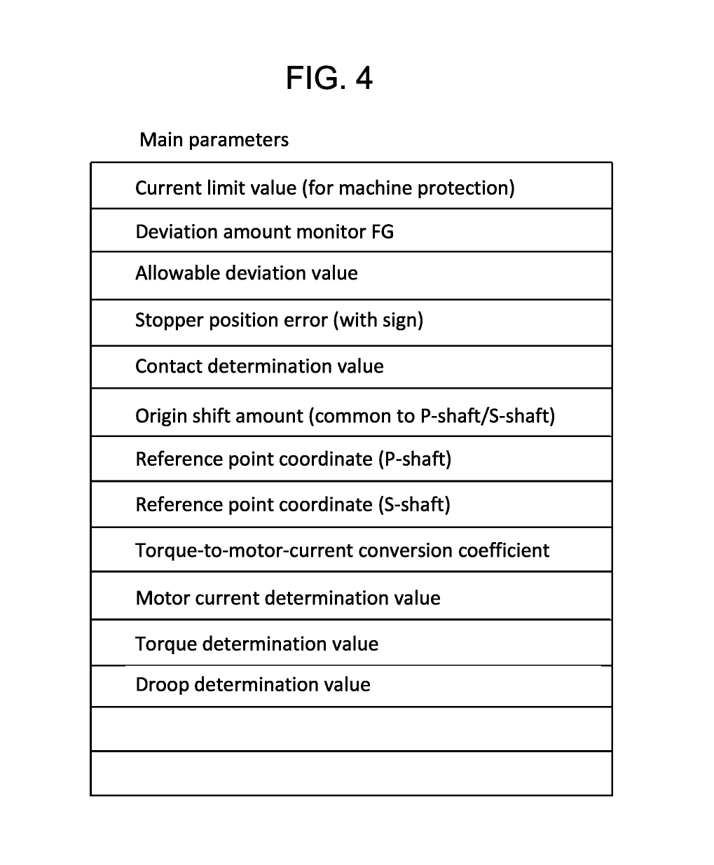

Information in the drive units 5a and 5b can be read by the control unit 3, and information can also be written from the control unit 3 into the drive units 5a and 5b. The parameter memorization unit 8 exists in memory, not shown in the figure, of the NC apparatus 1, and information necessary for NC control, such as that shown in FIG. 4, can be rewritably inputted from the configuration display panel 9, and the inputted content can be displayed on the screen of the configuration display panel 9.

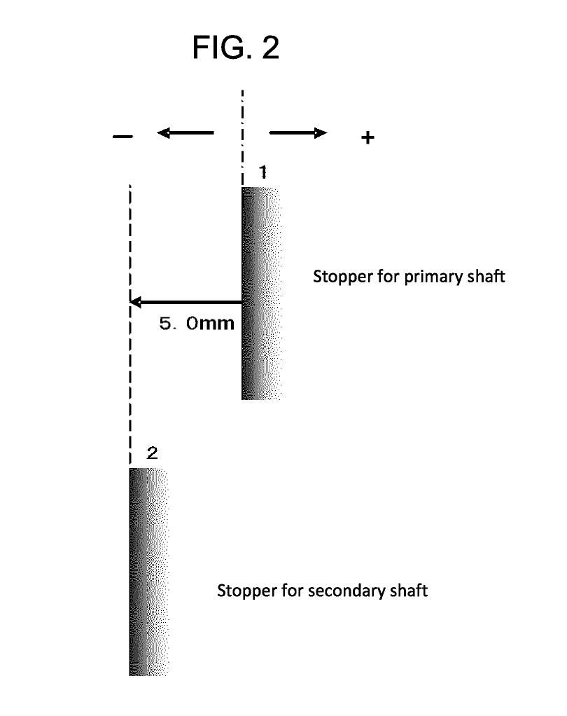

The mechanical position difference, as shown in FIG. 2 and later described, between the two mechanical end stoppers provided at predetermined machine positions for origin setting is stored as a stopper position error with a sign in the parameter memorization unit 8. The position error is divided so as not to exceed a maximum movement amount per unit time and added to the output of the control unit 3 by the movement correction units 10a and 10b.

In addition, the shaft to be corrected and the correction direction are determined by the sign. For example, in a case as shown in FIG. 2 where the stopper difference between the two shafts is “−5 mm”, the structural shaft parts of the two shafts are pushed into contact with the stoppers, and then the movement correction unit 10a adds just the amount of the difference, whereby the structural shaft part of the primary shaft is moved by 5 mm apart from the mechanical end stopper. Consequently, correction is made as if the mechanical end stopper for the primary shaft is located at the same position where the mechanical end stopper for the secondary shaft is located. On the other hand, in a case where the mechanical end stopper for the secondary shaft is located at “+5 mm” from the mechanical end stopper for the primary shaft, the structural shaft parts of the two shafts are pushed into contact with the stoppers, and then the movement correction unit 10b for the secondary shaft side adds the amount of the difference, whereby the structural shaft part of the secondary shaft is moved by 5 mm apart from the mechanical end stopper. By these operation, correction is made as if the secondary shaft stopper is located at the same position where the mechanical end stopper for the primary shaft is located.

In addition, in the embodiment, the position error between the mechanical end stoppers is corrected using the movement correction units 10a and 10b; however, the correction may also be made by individually outputting the position error from the position instruction generation unit 4, or by presetting the instruction position by adding the amount of the position error thereto, which causes a droop value in the drive units 5a and 5b so that an automatic function in servo loop causes automatically a movement by the preset addition amount. In short, the stopper position error can be corrected by using various methods.

In addition, the origin may be determined to be a position at which a grid point (outputted from an encoder) is detected first when the structural shaft parts of the two shafts are moved back from the reference points (positions where the structural shaft parts of the two shafts are pushed into contact with the mechanical end stoppers); however, the origin is generally set at a position that is further apart from the grid point by a predetermined distance in the direction away from the mechanical end stopper. Because of this, in this embodiment, in order to shift the origin by the predetermined distance, the worker sets an origin shift amount (the amount of the predetermined distance from the grid point) in the parameter memorization unit 8, using the configuration display panel 9. In addition, this predetermined distance value is common for the primary shaft and the secondary shaft.

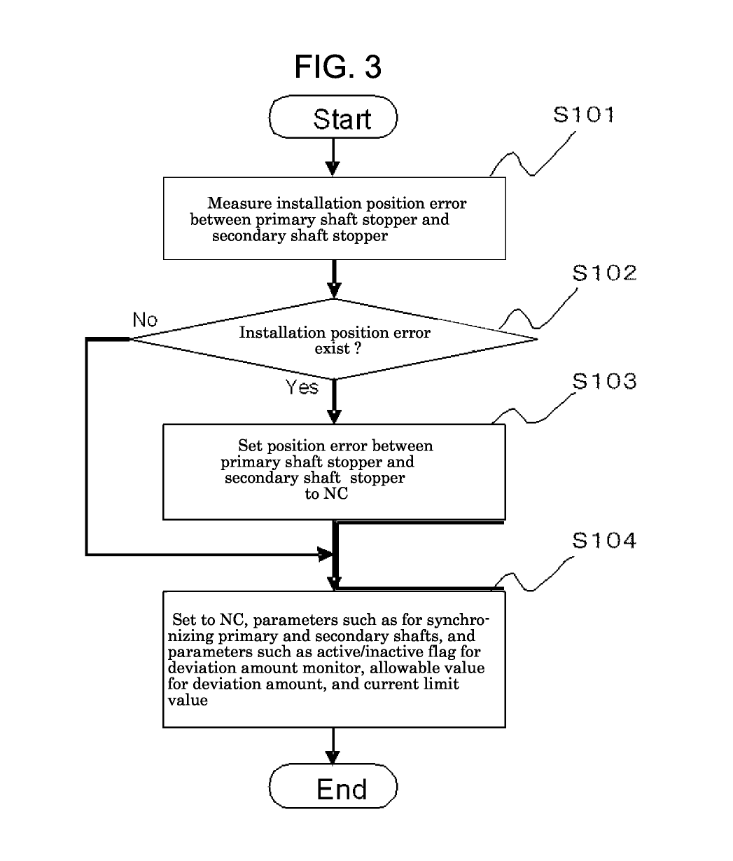

Next, an explanation will be made for an origin setting operation in the NC system configured as described above. In order to control more precisely, it is required to know in advance a deviation amount between positions of the installed mechanical end stoppers. For this requirement, a measurement is made for the installation position error, as shown in FIG. 2, between the mechanical end stoppers for the primary shaft and the secondary shaft, before the NC apparatus is operated. FIG. 3 shows a flow chart of a measuring sequence for the error and of data setting.

Firstly, by taking as a reference the push-contact face of the stopper for the primary shaft, a sufficiently narrowed laser beam is emitted, perpendicularly to the primary shaft, from the reference to a scale plate parallel to the secondary shaft. The scale plate is placed so as to indicate as a “zero” a push-contact face for the secondary shaft, so that the position irradiated with the laser beam indicates the position error between the face and the push-contact face for the primary shaft, whereby the installation position error between the stoppers is measured (Step S101). In addition, the measurement of the stopper installation position error may be made by using a method other than the laser measurement method as described above.

In Step S102, from the measurement result, the worker checks whether or not a stopper installation position error exists; if an error exists, Step S103 is performed so that the worker stores the stopper position error as numerical information listed in FIG. 4 with a sign as shown in FIG. 2 into the parameter memorization unit 8, using the configuration display panel 9. Next, in Step S104, the worker sets preparation data for setting an origin, such as a current limit value for controlling the motor torque to prevent the machine from being damaged, an allowable deviation value and a deviation amount monitor flag for preventing a forcible correction of an excessive deviation in the mechanical parts, and a value for determining the contact, i.e., for determining whether or not the structural shaft part is pushed into contact with the stopper, and then completes the operations. In addition, during the origin setting operation, the motor drive current is controlled so as not to exceed the current limit value, thereby limiting the torque to a small one; therefore, when the structural shaft part is pushed into contact with the stopper, no damage occurs.

If no error is found in Step S102, the operation sequence is diverted to Step S104, and then the data described above is set, thereby completing the operations.

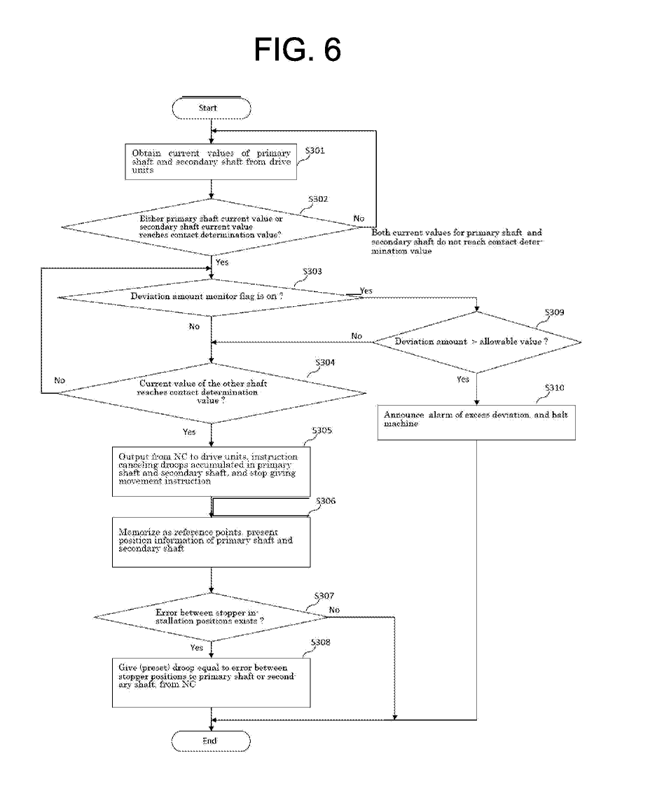

In addition, if the installation position error between the mechanical end stoppers is small and the error can be mechanically adjusted, the worker may adjust the installation position so that the installation position error between the mechanical end stoppers becomes “zero”; however, in this embodiment, a case is taken into account in which the installation position error between the mechanical end stoppers cannot be mechanically corrected. For this case, the system is configured in a manner that the installation position error between the stoppers to be adjusted (stopper position error) is stored, as numerical information listed in FIG. 4 with a sign as shown in FIG. 2, in the parameter memorization unit 8, using the configuration display panel 9, and then is read out during the origin setting operation as shown in FIG. 6 to correct the installation position error between the stoppers.

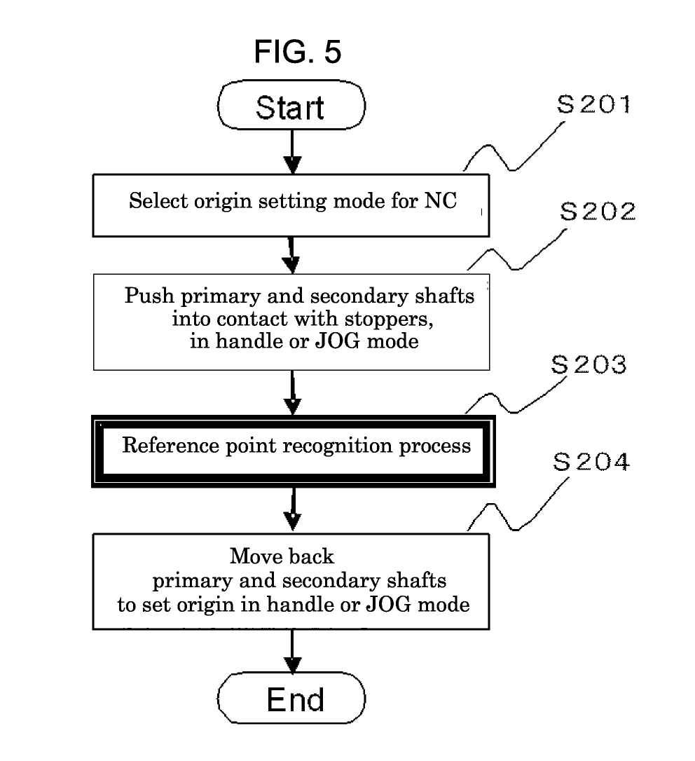

Next, an explanation will be made for operations of the origin setting process, using FIG. 5 to FIG. 7.

That is, as shown in FIG. 5, the worker operates the operation panel 2 of the NC apparatus to select an origin setting mode (Step S201). Next, “JOG” or “handle” (manual pulse generator) is selected as the manual feed mode on the operation panel 2; if “JOG” is selected, a feed speed is further set and a JOG button indicating a stopper direction is pushed. If “handle” is selected, a moving rate per revolution of handle is selected, and then, the handle is rotated to move the shaft toward the stopper.

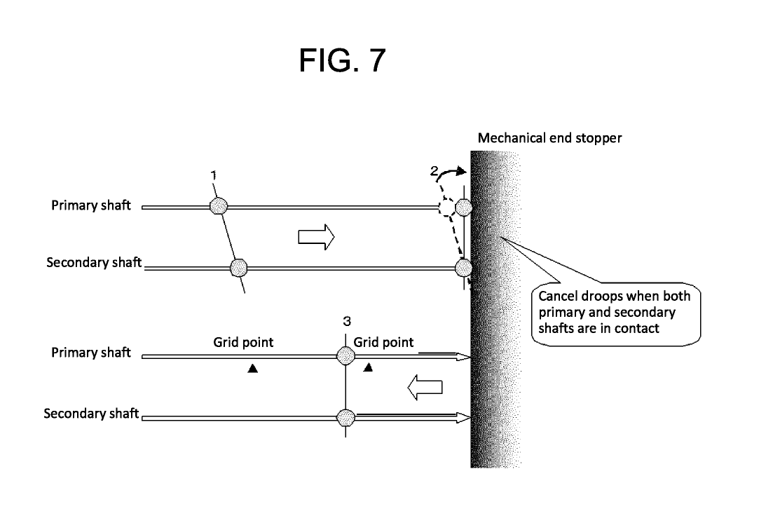

During these operations, the control unit 3 inputs identical predetermined movement data into the drive units 5a and 5b for the primary shaft and the secondary shaft, and the drive units 5a and 5b convert it to electric power to drive the servomotors 6a and 6b. To move to instruction positions, the detectors 7a and 7b feed back the movement amounts by the rotation of the servomotors 6a and 6b to the drive units 5a and 5b. At this time, because the identical movement instruction is simultaneously inputted for the primary shaft and the secondary shaft, even if the structural shaft part of the secondary shaft is pushed into contact with the mechanical end stopper for the secondary shaft as indicated at “2” in FIG. 7, the instruction is continuously inputted for the two shafts until the structural shaft part of the primary shaft is pushed into contact with the mechanical end stopper for the primary shaft (Step S202).

Next, a reference point recognition process is performed (Step S203). The reference point is determined as a position at which the motor current value reaches a predetermined value due to the push contact operation, the details of which will be explained later, using FIG. 6.

After the reference points for the primary shaft and the secondary shaft are set, the worker operates the JOG button or the handle to move back the primary shaft and the secondary shaft (move the structural shaft parts of the primary shaft and the secondary shaft away from the mechanical end stoppers), and sets as origins, positions moved back by an origin shift amount memorized in the parameter memorization unit 8 (Step S204). In addition, at this moment, the servomotors 6a and 6b automatically stop at the positions moved back by the origin shift amount memorized in the parameter memorization unit 8, and do not move further, even when the worker continues the backward movement operations. The arrival at the origin positions is displayed on the operation panel 2. In addition, “3” in FIG. 7 indicates the positions set as the origins.

Furthermore, the origin positions may not be set to the positions moved by the origin shift amount memorized in the parameter memorization unit 8, but may be set to positions at which grid points are first detected when the primary shaft and the secondary shaft are moved back.

Next, an explanation will be made, using FIG. 6, for the reference point recognition process of Step S203 in FIG. 5.

That is, in Step S301 of FIG. 6, the control unit 3 obtains current values of the motor 6a and 6b from the drive units 5a and 5b for the primary shaft and the secondary shaft to read their current values. In Step S302, the motor current values of the primary shaft and the secondary shaft are compared to the contact determination value that is a motor current determination value memorized in the parameter memorization unit 8; if the result is “No” (if neither of the motor current values for the shafts reaches the contact determination value), the previous process is periodically repeated until the primary shaft (or the secondary shaft) is pushed into contact with the mechanical end stopper for the structural shaft part (Yes).

If either of the structural shaft parts of the primary shaft and secondary shaft is pushed into contact with the mechanical end stopper and either of the motor current values for the shafts consequently reaches the contact determination value, the determination of Step 302 becomes “Yes”, whereby a deviation amount monitor flag in the parameter memorization unit 8 is checked in Step S303. If this flag is off (No), operations of Step S303 and Step S304 are repeated to continue outputting the movement instruction, until both structural shaft parts of the primary shaft and the secondary shaft are pushed into contact with the mechanical end stoppers whereby Step S304 determines that the both motor current values for the shafts reach the contact determination value. If the deviation amount monitor flag is on (Yes) in Step S303, the process moves to Step S309; however, if the deviation amounts (droops) of the two shafts do not exceed the allowable deviation value memorized in the parameter memorization unit 8, the process moves to Step S304 to repeat the operations of Step S303, Step S309, and Step S304, continuously giving the movement instruction.

In addition, the deviation amount monitor flag is set by the worker's discretion in order to prevent a machine damage caused by a forcible correction in a case where the deviation between the mechanical positions of the mechanical end stoppers for the primary shaft and the secondary shaft is large (a case where a mechanical part bridging the two parallel shafts (the primary shaft and the secondary shaft) is greatly misaligned in perpendicularity with respect to the shafts).

If both structural shaft parts of the primary shaft and the secondary shaft are pushed into contact with the mechanical end stoppers (the motor current values for the two shafts reach the contact determination value), the result of Step S304 becomes “Yes” and then the process proceeds to Step S305. In Step S305, the control unit 3 outputs an instruction to the drive units 5 to cancel droops accumulated for the primary shaft and the secondary shaft, and then, on the basis of the instruction the drive units 5 stop giving the movement instruction to the motors 6a and 6b.

In Step S306, the current position information of the primary shaft and the secondary shaft is stored as the reference points in the parameter memorization unit 8. In addition, the reference points are memorized as a reference point coordinate (P-shaft) and a reference point coordinate (S-shaft) listed in FIG. 4 in the parameter memorization unit 8.

In addition, in a case where the mechanical part is distorted as “1” indicated in FIG. 7 (the mechanical part is not installed perpendicularly to the parallel shafts) but there is no error between the mechanical end stoppers as “2” indicated in FIG. 7, the distortion is corrected by pushing the two structural shaft parts against the mechanical end stoppers.

Step S307 checks whether or not there is an error between the mechanical end stopper installation positions for the primary shaft and the secondary shaft. This can be performed by, for example, checking the content of the stopper position error in the parameter memorization unit 8. If the result is “Yes”, the process proceeds to Step S308, so that the structural shaft part of the primary shaft or the secondary shaft is moved, as has been described using FIG. 2, apart from the mechanical end stopper by the amount of the stopper position error. More specifically, the structural shaft part of the primary shaft or the secondary shaft is moved apart from the mechanical end stopper by the stopper position error amount, using the above-described method such as the method of giving an instruction for movement by the stopper position error amount, the method of correction by the movement correction units 10a and 10b, or the method of writing the stopper position error amount as a droop into the drive units 5a and 5b.

As a result, the installation position error between the mechanical end stoppers is corrected, as described above using FIG. 2.

Furthermore, in a case where an installation position error between the mechanical end stoppers exists and the mechanical part is not distorted (mechanical part installed perpendicularly to the parallel shafts), the mechanical part is distorted when the structural shaft parts of the two shafts are pushed into contact with the mechanical end stoppers; however, execution of Step S308 corrects the distortion of the mechanical part.

Moreover, even in a case where an installation position error between the mechanical end stoppers exists and the mechanical part is distorted (the mechanical part is not installed perpendicularly to the parallel shafts), when the structural parts of both shafts are pushed into contact with the respective mechanical end stoppers, the distortion of the mechanical part is corrected to only distortion due to the installation position error between the mechanical end stoppers and then, the distortion is further corrected by executing the process of Step S308 (the mechanical part is corrected to a state that the mechanical part is not distorted).

If Step S303 determines that the deviation amount monitor flag in the parameter memorization unit 8 is on, the process proceeds to Step S309 to monitor the droop of the firstly contacting shaft and check whether or not the deviation amount (droop) exceeds the allowable deviation value. This is aimed at preventing machine damages caused by forcible correction of a large position deviation between the mechanical end stoppers for primary shaft and secondary shaft; thus, if the deviation amount exceeds the allowable value, the process proceeds to Step S310 to issue an alarm of excess deviation and halt the machine, ending the operations. By using the deviation amount monitor flag, it can be selected whether or not an alarm is issued when the mechanical end stopper installation error between the primary shaft and the secondary shaft is too large.

As described above, origin setting according to the embodiment is performed in a manner that the two shafts of the primary shaft and the secondary shaft are independently controlled to be pushed into contact with the mechanical end stoppers; when detecting the two shafts' contacts, the contact positions are set as reference points and the droop amounts are cleared; and then, the two shafts are moved apart from the mechanical end stoppers by predetermined amounts. Therefore, even if a mechanical part bridging the two shafts and movably placed thereon has a deviation in perpendicularity, the origins with reference to the positions of the mechanical end stoppers for the two shafts can be precisely set with a simple configuration.

Furthermore, another origin setting is performed in a manner that the two shafts of primary shaft and secondary shaft are independently controlled and pushed against the mechanical end stoppers; when detecting the two shafts' contacts, the contact positions are set as reference points and the droop amounts are cleared; either of the shafts is moved, for correcting error, apart from the mechanical end stopper by a predetermined amount that eliminates the mechanical end stopper installation position error between the two shafts; and then, the two shafts are moved apart from the mechanical end stoppers by predetermined amounts. Therefore, even if a mechanical part bridging the two shafts and movably placed thereon has a deviation in perpendicularity and there is a mechanical end stopper position error between the two shafts, the origins can be precisely set with a simple configuration.

Furthermore, because the contacts between the structural shaft parts and the mechanical end stoppers are detected when the motor current values exceed a predetermined value, the origin setting can be performed with a simple configuration.

In addition, in the embodiment described above, contact detection between each of the two structural shaft parts of primary shaft and secondary shaft and the mechanical end stopper is based on comparison of the motor current values; however, the detection may be performed based on the motor torque values. In this case, the motor current determination value is converted in advance by using a torque-to-motor-current conversion coefficient, to thereby realize the detection. The comparison/detection may also be made by using a droop value for determining the contact, as with the case of using motor current or torque.

Moreover, because the contact between the structural shaft part and the mechanical end stopper is detected by the fact that the droop amount of each shaft exceeds a predetermined value, the origin can be set with a simple configuration.

### INDUSTRIAL APPLICABILITY

An origin setting method and an apparatus using the same according to the present invention are suitable for setting origins of a machine tool provided with an NC apparatus, that has parallel shafts composed of a primary shaft and a secondary shaft.

### NUMERALS

1 NC apparatus
2 operation panel
3 control unit
4 position instruction generation unit
5a, 5b drive unit
6a, 6b servomotor
7a, 7b detector
8 parameter memorization unit
9 configuration display panel
10a, 10b movement correction unit

1-14. (canceled)

15. An origin setting method for a machine in which two control shafts constituting a single mechanical movement axis are cooperatively servo-controlled and driven, the method comprising:
a step of moving structural shaft parts of the respective control shafts, which are moved by driving the control shafts, until the structural shaft parts are brought into contact with respective mechanical end stoppers;
a step of detecting contact between each structural shaft part and the mechanical end stopper;
a step of reading and memorizing a contact detection position of each control shaft under a condition that each structural shaft part is in contact with the mechanical end stopper;
a step of clearing a droop amount of each control shaft under the condition that each structural shaft part is in contact with the mechanical end stopper; and
a step of setting origins to positions obtained by moving the structural shaft parts from the memorized contact detection positions by a predetermined amount apart from the mechanical end stoppers.

16. The origin setting method according to claim 15, further comprising;
a step of eliminating an installation position error between the mechanical end stoppers.

17. An origin setting method for a machine in which two control shafts constituting a single mechanical movement axis are cooperatively servo-controlled and driven, the method comprising:
a step of measuring an installation position error between positions at which structural shaft parts of the control shafts, which are moved by driving the control shafts, are in contact with respective mechanical end stoppers;
a step of memorizing a value of the installation position error;
a step of moving the structural shaft parts, until the structural shaft parts are brought into contact with the respective mechanical end stoppers;
a step of detecting contact between each structural shaft part and the mechanical end stopper;
a step of reading and memorizing a contact detection position of each control shaft under a condition that each structural shaft part is in contact with the mechanical end stopper;
a step of clearing a droop amount of each control shaft under the condition that each structural shaft part is in contact with the mechanical end stopper;
a step of eliminating the installation position error between the mechanical end stoppers, on a basis of the memorized value of the installation position error; and
a step of setting origins to positions obtained by moving the structural shaft parts from the memorized contact detection positions by a predetermined amount apart from the mechanical end stoppers.

18. The origin setting method according to claim 17, wherein the step of eliminating the installation position error between the mechanical end stoppers is a step of moving one of the structural shaft parts of the shafts apart from the mechanical end stopper.

19. The origin setting method according to claim 18, wherein the step of setting origins is performed after performing the step of eliminating the installation position error between the mechanical end stoppers.

20. The origin setting method according to claim 15, wherein contact between each structural shaft part and the mechanical end stopper is detected on a basis of a consequence that a driving current of a motor driving the control shaft exceeds a predetermined value.

21. The origin setting method according to claim 17, wherein contact between each structural shaft part and the mechanical end stopper is detected on a basis of a consequence that a driving current of a motor driving the control shaft exceeds a predetermined value.

22. The origin setting method according to claim 15, wherein contact between each structural shaft part and the mechanical end stopper is detected on a basis of a consequence that the droop amount of a servo-controlled motor driving each control shaft exceeds a predetermined value.

23. The origin setting method according to claim 17, wherein contact between each structural shaft part and the mechanical end stopper is detected on a basis of a consequence that the droop amount of a servo-controlled motor driving each control shaft exceeds a predetermined value.

24. An origin setting apparatus in a machine in which two control shafts constituting a single mechanical movement axis are cooperatively servo-controlled and driven, comprising:
a movement means that moves structural shaft parts of the respective control shafts, which are moved by driving the control shafts, until the structural shaft parts are brought into contact with respective mechanical end stoppers;
a contact detection means that detects contact between each structural shaft part and the mechanical end stopper;
a detected-contact-position memorization means that reads and memorizes a contact detection position of each control shaft under a condition that each structural shaft part is in contact with the mechanical end stopper;
a droop amount clearing means that clears a droop amount of each control shaft under the condition that each structural shaft part is in contact with the mechanical end stopper; and
an origin setting means that sets origins to positions obtained by moving the structural shaft parts from the contact detection positions, memorized in the detected-contact-position memorization means, by a predetermined amount apart from the mechanical end stoppers.

25. The origin setting apparatus according to claim 24, further comprising:
a position error elimination means that eliminates an installation position error between the mechanical end stoppers.

26. An origin setting apparatus in a machine in which two control shafts constituting a single mechanical movement axis are cooperatively servo-controlled and driven, comprising:
an error memorization means that memorizes an installation position error between mechanical end stoppers with which respective structural shaft parts of the control shafts, which are moved by driving the control shafts, are brought into contact;
a movement means that moves structural shaft parts until the structural shaft parts are brought into contact with the respective mechanical end stoppers;
a contact detection means that detects contact between each structural shaft part and the mechanical end stopper;
a detected-contact-position memorization means that reads and memorizes a contact detection position of each control shaft under a condition that each structural shaft part is in contact with the mechanical end stopper;
a droop amount clearing means that clears a droop amount of each control shaft under the condition that each structural shaft part is in contact with the mechanical end stopper;
a position error elimination means that eliminates the installation position error between the mechanical end stoppers, on a basis of an error value memorized in the error memorization means; and
an origin setting means that sets origins to positions obtained by moving the structural shaft parts from the contact detection positions, memorized in the detected-contact-position memorization means, by a predetermined amount apart from the mechanical end stoppers.

27. The origin setting apparatus according to claim 26, wherein the position error elimination means moves one of the structural shaft parts of the shafts apart from the mechanical end stopper.

28. The origin setting apparatus according to claim 27, wherein the origin setting means operates after the position error elimination means operates.

29. The origin setting apparatus according to claim 24, wherein the contact detection means detects contact between each structural shaft part and the mechanical end stopper on the basis of a consequence that a driving current of a motor driving the control shaft exceeds a predetermined value.

30. The origin setting apparatus according to claim 26, wherein the contact detection means detects contact between each structural shaft part and the mechanical end stopper on the basis of a consequence that a driving current of a motor driving the control shaft exceeds a predetermined value.

31. The origin setting apparatus according to claim 24, wherein the contact detection means detects contact between each structural shaft part and the mechanical end stopper on the basis of a consequence that the droop amount of a servo-controlled motor driving each control shaft exceeds a predetermined value.

32. The origin setting apparatus according to claim 26, wherein the contact detection means detects contact between each structural shaft part and the mechanical end stopper on the basis of a consequence that the droop amount of a servo-controlled motor driving each control shaft exceeds a predetermined value.
